(19) United States
(12) Patent Application Publication
(10) Pub. No.: US 2025/0019981 A1
(43) Pub. Date: Jan. 16, 2025

(54) CONCRETE FINISHING EDGER

(71) Applicant: Rusty Gene Tennison, The Dalles, OR (US)

(72) Inventor: Rusty Gene Tennison, The Dalles, OR (US)

(21) Appl. No.: 18/350,704

(22) Filed: Jul. 11, 2023

(51) Int. Cl. E04F 21/16; B28B 11/08; E01C 19/17

(52) U.S. Cl. CPC E04F 21/161; B28B 11/0809; E01C 19/178

(57) ABSTRACT

An example operation includes one or more of shaping vertical edges of wet concrete using concrete finishing edger tool, wherein the concrete finishing edger tool comprises a rounded shaping element portion with a radius from around ⅛ inch to around 1 inch, a tang, and a handle, wherein the vertical edges are shaped prior to the removal of a form surrounding the concrete.

### BACKGROUND

The subject matter of the current disclosure relates to construction tools, specifically to a concrete finishing edger tool for shaping and finishing concrete structures. Conventionally, concrete edger tools are used to provide a finished edge on horizontal surfaces such as walkways, driveways, and patios. However, these traditional tools have proven to be less effective in shaping and finishing vertical edges such as vertical corners on stairs, tall porch corners, or tight fits around studs or pipes before the removal of concrete forms. This is primarily due to their size and form factor, which do not allow them to access these tight or limited spaces. Consequently, finishes can be inconsistent and non-uniform, with the vertical edges typically not finished until the concrete forms are removed. This limitation often results in additional labor and costs due to the need for subsequent touch-ups or corrections. Moreover, it prevents contractors from achieving a professional, uniform finish across the entire concrete structure in a single operation.

### SUMMARY

One example embodiment provides a concrete finishing edger tool that includes one or more of a handle, a shaping element comprising a rounded portion with a radius from around ⅛ inch to around 1 inch, and a tang, wherein the tang, the handle and the shaping element are coupled.

Another example embodiment provides a method that includes one or more of shaping vertical edges of wet concrete using a concrete finishing edger tool, wherein the concrete finishing edger tool comprises a rounded shaping element portion with a radius from around ⅛ inch to around 1 inch, a tang, and a handle, wherein the vertical edges are shaped prior to the removal of a form surrounding the concrete.

### BRIEF DESCRIPTION OF THE DRAWINGS

FIG. 1 illustrates a top view of a concrete finishing edger tool, according to example embodiments.

FIG. 2 illustrates a side view of a concrete finishing edger tool, according to example embodiments.

FIG. 3 illustrates a bottom view of a concrete finishing edger tool, according to example embodiments.

FIG. 4 illustrates an example process of using a concrete finishing edger tool, according to example embodiments.

FIG. 5 illustrates an example method of finishing the edges of a concrete structure with a concrete finishing edger tool, according to example embodiments.

FIG. 6 illustrates another example method of finishing the edges of a concrete structure with a concrete finishing edger tool, according to example embodiments.

FIG. 7 illustrates a concrete finishing edger tool with an extendable shaping element, according to example embodiments.

FIG. 8 illustrates a concrete finishing edger tool with detachably attached shaping elements with different radii and lengths, according to example embodiments.

FIG. 9 illustrates a concrete finishing edger tool with an adjustable tang, according to example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method and apparatus as represented in the attached figures, is not intended to limit the scope of the application as claimed but is merely representative of selected embodiments. Multiple embodiments depicted herein are not intended to limit the scope of the solution.

The subject matter of the current disclosure relates to construction tools, specifically to a concrete finishing edger tool for shaping and finishing concrete structures. Conventionally, concrete edger tools are used to provide a finished edge on horizontal surfaces such as walkways, driveways, and patios. However, these traditional tools have proven to be less effective in shaping and finishing vertical edges such as vertical corners on various structures such as stairs, porch corners, tight fits around studs or pipes, and the like before the removal of concrete forms. This is primarily due to their size and form factor, which do not allow them to access these tight or limited spaces. Consequently, finishes can be inconsistent and non-uniform, with the vertical edges typically not finished until the concrete forms are removed. This limitation often results in additional labor and costs due to the need for subsequent touch-ups or corrections. Moreover, it prevents individuals, such as contractors and others, from achieving a professional, uniform finish across the entire concrete structure while the concrete is still wet. Therefore, there is a need for an improved concrete finishing edger tool that can effectively and efficiently shape and finish vertical edges of a concrete structure before the concrete forms are removed.

Timing is key when finishing concrete. This tool allows for all finishes to be done while the concrete is still wet instead of racing against time after removing the concrete forms. As soon as the forms are pulled (removed), the concrete starts drying at a much faster pace. The rate of drying can be influenced by weather (temperature, humidity, sun/shade exposure, wind exposure, etc.). Besides the timing benefit, there are other benefits to finishing edges while wet. For example, the act of finishing the vertical edge with this tool can be done by an inexperienced finisher instead of needing a skilled finisher to perform the finishing of vertical edges. This is due to the concrete still being wet and easy to manipulate. If the concrete is already partially dry, the skill level required increases exponentially as the concrete will begin to crumble and fall apart as it dries. This is further complicated by the stairs drying at different rates and the need to judge each stair individually. Using this tool, an individual may prevent all of the timing and drying effects and reduce the skill level required to finish the edges as you are just dipping the tool along a form in wet mud/concrete. After finishing the edges, the concrete forms are still pulled (removed). However, the vertical edges are complete.

In one embodiment, the concrete finishing edger tool comprises three key components: a shaping element, a handle, and a tang. These three parts are interconnected, forming a versatile tool for creating uniform finishes on concrete structures. In one embodiment, the concrete finishing edger tool enables an individual to finish the vertical edges of a concrete structure while the forms are intact, and the concrete is still wet. In another embodiment, the concrete finishing edger tool enables an individual to get to limited access areas of a concrete structure, such as pipe penetrations, post penetrations, slab edges, cut lines, cut joints, instances, and irregular angles.

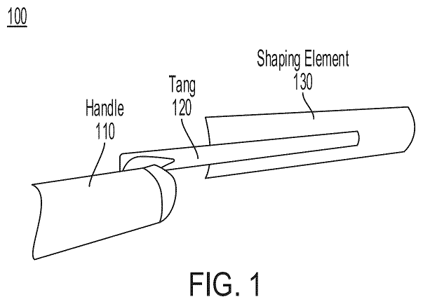

FIG. 1 illustrates an example top view of a concrete finishing edger tool 100. The concrete finishing edger tool comprises a handle 110, a tang 120, and a shaping element 130.

In one embodiment, the shaping element 130 of the tool 100 includes a rounded portion with a radius that ranges from around ⅛ inch to around 1 inch. This variety of radii of the shaping element 130 accommodates various edge requirements, enabling the user to create different edge finishes depending on the specific needs of the project. For most common applications, the ideal radius of the rounded portion of the shaping element 130 is between ½ inch and ¾ inch. It should be noted that the term “around”, as used herein, can mean the exact measurements noted or measurements within a reasonable range of the exact measurements noted. For example, the rounded portion may have a radius of exactly ⅛ inch or 1 inch. Further, the rounded portion may have a radius of 1/16 inch to 1¼ inches.

In another embodiment, the length of the shaping element 130 may vary between around 4 inches and around 42 inches, providing adaptability for different task dimensions. The ideal length of the shaping element is between around 7 inches and around 11 inches (typical for vertical edges on stairs while in forms), and another is between around 25 inches and around 29 inches (typical for vertical edges of a front porch while in forms).

In another embodiment, the shaping element 130 is preferably constructed from a high-carbon steel metal of approximately 16 gauge to 20 gauge. However, the tool can be made using a range from 9 gauge to 24 gauge, depending on the strength of the materials used. The specific metal and gauge combination contributes to the tool's durability, enhancing its performance and lifespan. The tool may also be constructed from graphene, magnesium, or another similar material.

In one embodiment, the tang 120, which is the part of the tool that attaches the handle 110 to the shaping element 130, is offset from the handle by around 1 inch to around 2 inches. This offset provides comfortable handling and enables precise control over the tool during use. However, the offset may range from between ½ inch to 4 inches based on preference. In another embodiment, the handle 110 is attached to the tang 120 with no offset.

In another embodiment, the handle 110, tang 120, and shaping element 130 of the concrete finishing edger tool 100 may be constructed of either the same or different materials. This versatile design approach provides an array of options for tool fabrication, potentially allowing for tailoring to specific application requirements or user preferences. In scenarios where the handle, tang, and shaping element are made from the same material, it can offer uniformity in structural integrity and balanced weight distribution across the tool. This could also simplify the manufacturing process by using a single type of material. On the other hand, choosing different materials for the handle, tang, and shaping element might optimize the tool's overall performance. For instance, a material that provides a comfortable and secure grip could be used for the handle, while a highly durable, wear-resistant material could be ideal for the shaping element and tang. The attachment between the handle, tang, and shaping element can be accomplished through various methods. These methods might include but are not limited to, welding, bolting, riveting, or even a snap-fit or other types of detachable connections. The choice of attachment technique can be determined by factors such as the materials used, the desired durability of the connection, and whether or not the tool is intended to be adjustable or modular. This flexibility in material selection and attachment method means the concrete finishing edger tool can be designed to meet a wide variety of specific construction needs and preferences, enhancing its versatility and usability in the field.

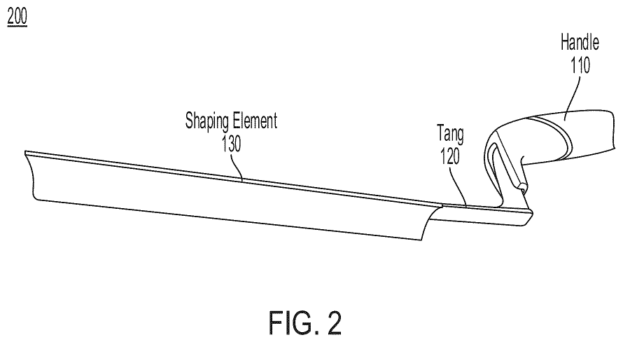

FIG. 2 illustrates an example side view of a concrete finishing edger tool 200. The concrete finishing edger tool 200 comprises a handle 110, a tang 120, and a shaping element 130.

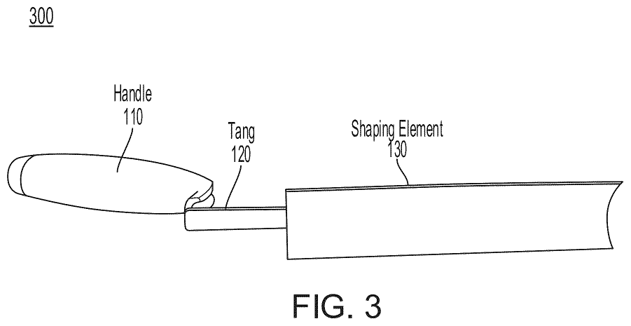

FIG. 3 illustrates an example bottom view of a concrete finishing edger tool 300. The concrete finishing edger tool 300 comprises a handle 110, a tang 120, and a shaping element 130.

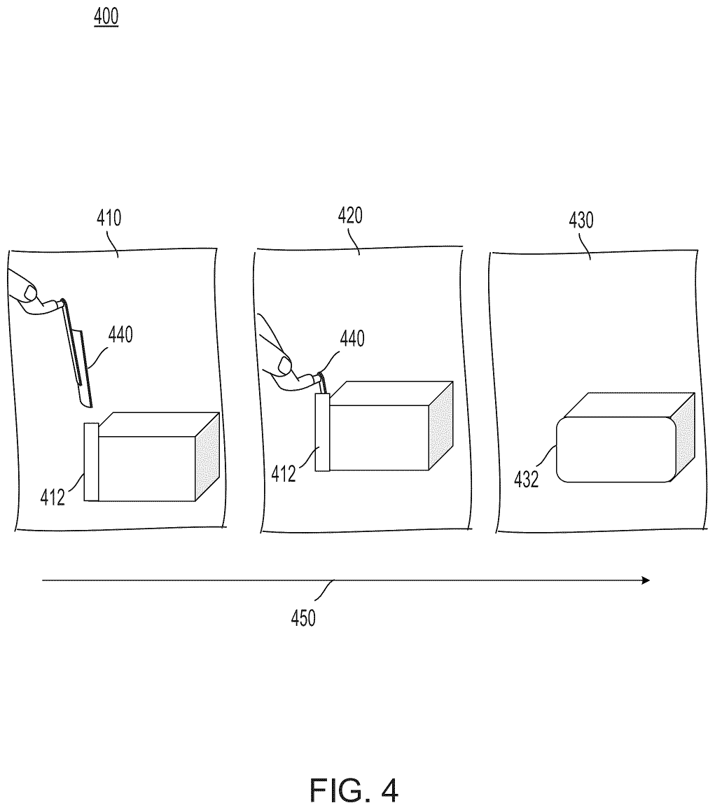

FIG. 4 illustrates an example process 400 of using a concrete finishing edger tool 440. Views 410, 420, and 430 occur over a sequence of time 450. In view 410, concrete forms 412 surround wet concrete making a concrete structure that provides support and allows the concrete structure to dry. The concrete finishing edger tool 440 is held vertically in preparation for finishing the vertical edges of the concrete structure. In view 420, the concrete finishing edger tool 440 is placed into the wet concrete against the concrete form 412 before being removed. This process is repeated for each vertical edge of the concrete structure in order to shape the concrete structure while the concrete is still wet. In view 430, the concrete structure has dried, and the concrete forms 412 have been removed, revealing the finished vertical and rounded edge(s) 432.

The amount of time that has elapsed 450 depends on various factors, including the rate of drying, which can be influenced by weather (temperature, humidity, sun/shade exposure, wind exposure, etc.). The average timing of view 410 and 420 is between 0-45 minutes, and the average timing of completing the entire process (410, 420, and 430) is between 0-4 hours.

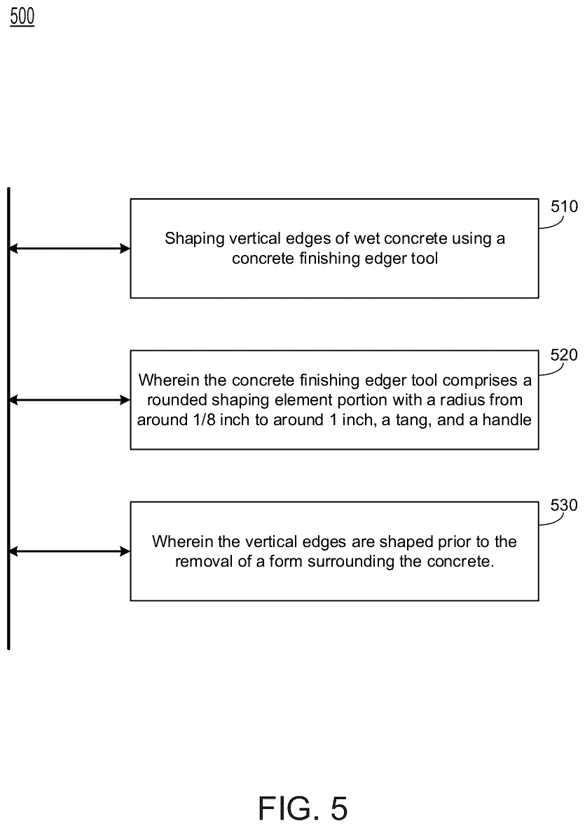

FIG. 5 illustrates a method 500 of shaping vertical edges of wet concrete using a concrete finishing edger tool, wherein the concrete finishing edger tool comprises a rounded shaping element portion with a radius from around ⅛ inch to around 1 inch, a tang, and a handle, wherein the vertical edges are shaped prior to the removal of a form surrounding the concrete. It should be noted that shaping the vertical edges includes rounding, curving, finishing, and/or smoothing the vertical edges prior to the removal of the forms.

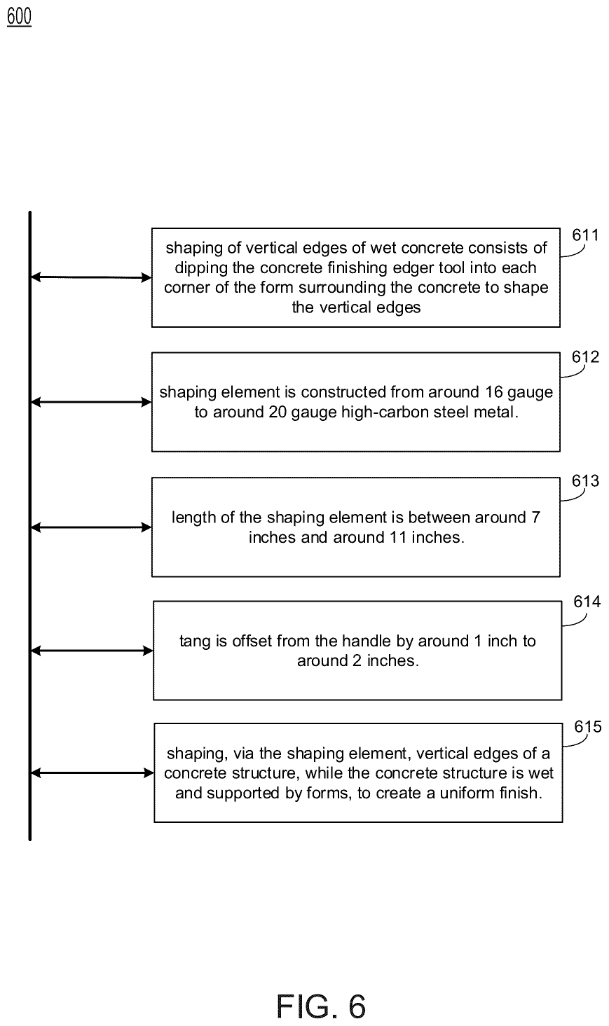

FIG. 6 illustrates another example method 600 of finishing the edges of a concrete structure with a concrete finishing edger tool. Referring now to FIG. 6, in some embodiments, in 611 the method may include shaping of vertical edges of wet concrete consisting of dipping the concrete finishing edger tool into each corner of the form surrounding the concrete to finish the vertical edges. In 612, the method may include a shaping element that is constructed from around 16 gauge to around 20 gauge high-carbon steel metal. In 613, the method may include the length of the shaping element being between around 7 inches and around 11 inches. In 614, the method may include the tang being offset from the handle by around 1 inch to around 2 inches. In 615, the method may include shaping, via the shaping element, vertical edges of a concrete structure, while the concrete structure is wet and supported by forms to create a uniform finish.

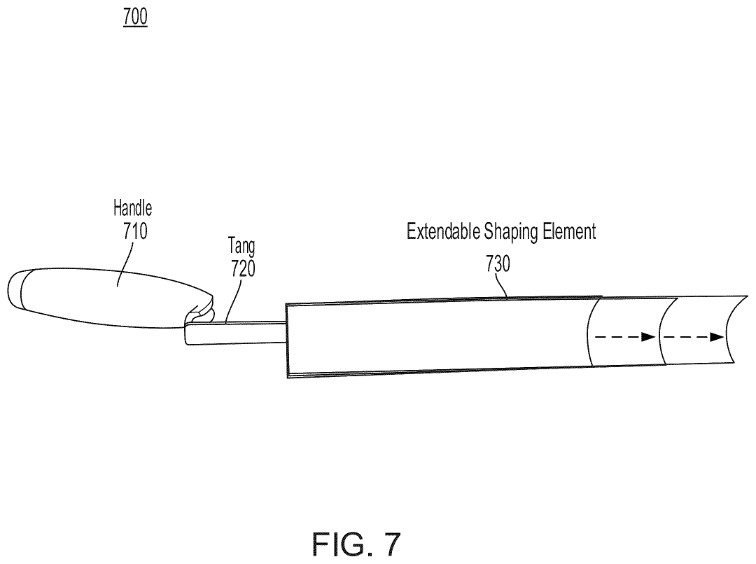

FIG. 7 illustrates a concrete finishing edger tool 700 with an extendable shaping element 730, to reach different depths of a concrete structure. The concrete finishing edger tool comprises a handle, 710, a tang 720, and an extendable shaping element 730. The extendable shaping element 730 allows the tool to reach varying depths of a concrete structure. The extendable shaping element 730 can be extended as required to accommodate the different depths, ensuring thorough and precise finishing. Once the task is completed, the shaping element can be easily retracted, contributing to the tool's compactness and ease of storage. The tool's innovative design boosts its adaptability significantly, enabling it to handle various forms and depths of concrete. This implies that with this single tool, a variety of concrete finishing tasks can be accomplished with improved efficiency and precision.

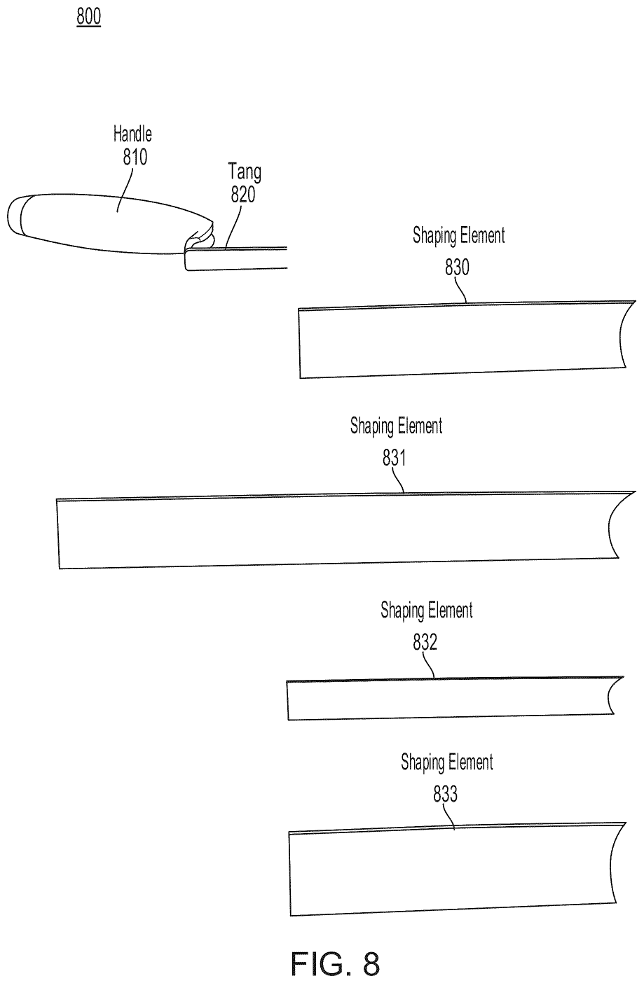

FIG. 8 illustrates a concrete finishing edger tool 800 with a detachably attached shaping elements. The concrete finishing edger tool comprises a handle, 810, a tang 820, and one or more extendable shaping elements 830, 831, 832, 833. The detachably attached shaping elements 830, 831, 832, and 833 are attached to the tang 820 and comprise a different radius of the rounded portion and/or a different length. This unique arrangement enables the easy swapping of the shaping element, catering to the specific needs of each concrete structure. Various other shaping elements with differing radii and lengths can be attached in a detachable manner to the tang. This flexibility permits the shaping of concrete structures with a wide array of geometrical complexities and depths. The detachably attached shaping elements allow for an extensive range of concrete shaping tasks to be conducted with precision and efficiency. The ease of detaching and reattaching different shaping elements to the tang also contributes to the tool's compactness, convenience, and adaptability. The shaping elements can be detachably attached from the tang by being snapped/unsnapped, slotted and pushed forwards/backwards/up/down, and the like. In this embodiment, the shaping elements and the tang would include the appropriate structures to permit such detachably attached capabilities.

In another embodiment, the concrete finishing edger tool features a detachable design. One or both of the shaping element and the handle can be detached from the tang. This allows for the attachment of other shaping elements with different radii and lengths or other handles or tangs with varying offsets, as required by the specifics of a concrete project. Additionally, other handles or tangs with different offsets (or no offset at all) can also be attached based on the unique requirements of the concrete project. This feature allows for a single tool to be dynamically adjusted, ensuring optimal performance across a wide array of concrete finishing tasks.

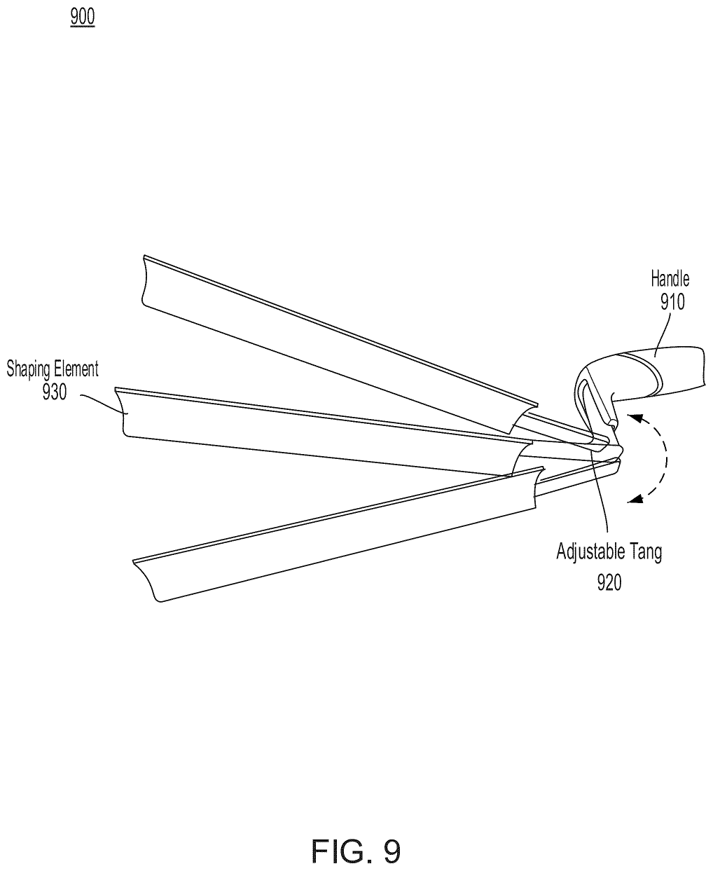

FIG. 9 illustrates a concrete finishing edger tool 900 with an adjustable tang 920. The concrete finishing edger tool comprises a handle, 910, an adjustable tang 920, and a shaping element 930. In this example embodiment, the adjustable tang 920 allows for changes in the angle of the shaping element 930 relative to a concrete structure. The purpose of the adjustable tang is to allow the user to modify the angle between the shaping element 930 and the concrete structure being worked on. This provides an additional layer of adaptability and versatility to the tool's design, as it enables the tool to be adjusted and fine-tuned according to the specifics of a given concrete finishing task. By allowing alterations in the angle of the shaping element relative to the concrete structure, this tool can cater to a wide array of working conditions and scenarios, thereby optimizing its utility in various concrete finishing operations.

In yet another embodiment, the tang is adjustable, allowing for changes in the angle of the shaping element relative to a concrete structure. This enhances the tool's versatility and adaptability, enabling it to accommodate a variety of different work scenarios.

In another embodiment, a method for shaping vertical edges of wet concrete using the concrete finishing edger tool. This method involves shaping the vertical edges before removing the form surrounding the concrete. Specifically, the method involves dipping the concrete finishing edger tool into each corner of the form surrounding the concrete to finish the vertical edges. This leads to more precise, high-quality edge finishes, enhancing the aesthetics and structural integrity of the finished concrete structure.

In another embodiment, “edges” is meant to be a vertical edge, corner, irregular angle, pipe/post penetration, slab edge, cut line, cut joint.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

What is claimed is:

1. A concrete finishing edger tool, comprising:
a handle;
a shaping element comprising a rounded portion with a radius from around ⅛ inch to around 1 inch; and
a tang, wherein the tang, the handle and the shaping element are coupled.

2. The concrete finishing edger tool of claim 1, wherein the shaping element is constructed from around 16 gauge to around 20 gauge high-carbon steel metal.

3. The concrete finishing edger tool of claim 1, wherein the length of the shaping element is between around 7 inches and around 11 inches.

4. The concrete finishing edger tool of claim 1, wherein the tang is offset from the handle by around 1 inch to around 2 inches.

5. The concrete finishing edger tool of claim 1, wherein the shaping element is configured to shape vertical edges of a concrete structure, while the concrete structure is wet and supported by forms, to create a uniform finish.

6. The concrete finishing edger tool of claim 1, wherein the shaping element is configured to fit in limited access areas of a concrete structure while supported by forms, wherein the limited access areas include one or more of pipe penetration, post penetration, slab edge, cut line, cut joint, instance and irregular angle.

7. The concrete finishing edger tool of claim 1, wherein the shaping element is configured to be extendable to reach different depths of a concrete structure, wherein once the shaping element is extended, it is further configured to be retracted.

8. The concrete finishing edger tool of claim 1, wherein the shaping element is detachably attached to the tang and wherein other shaping elements with different radii and lengths can be detachably attached for shaping a concrete structure.

9. The concrete finishing edger tool of claim 1, wherein the tang is adjustable to change an angle of the shaping element relative to a concrete structure.

10. The concrete finishing edger tool of claim 1, wherein the handle is detachably attached to the tang and wherein other handles with varying offsets can be detachably attached.

11. A method, comprising:
shaping vertical edges of wet concrete using a concrete finishing edger tool;
wherein the concrete finishing edger tool comprises a rounded shaping element portion with a radius from around ⅛ inch to around 1 inch, a tang, and a handle;
wherein the vertical edges are shaped prior to the removal of a form surrounding the concrete.

12. The method of claim 11, wherein the shaping of vertical edges of wet concrete consists of dipping the concrete finishing edger tool into each corner of the form surrounding the concrete to shape the vertical edges.

13. The method of claim 11, wherein the shaping element is constructed from around 16 gauge to around 20 gauge high-carbon steel metal.

14. The method of claim 11, wherein the length of the shaping element is between around 7 inches and around 11 inches.

15. The method of claim 11, wherein the tang is offset from the handle by around 1 inch to around 2 inches.

16. The method of claim 11, further comprising shaping, via the shaping element, vertical edges of a concrete structure, while the concrete structure is wet and supported by forms, to create a uniform finish.

17. The method of claim 11, wherein the shaping element is configured to be extendable to reach different depths of a concrete structure, wherein once the shaping element is extended, it is further configured to be retracted.

18. The method of claim 11, wherein the shaping element is detachably attached to the tang and wherein other shaping elements with different radii and lengths can be detachably attached for shaping a concrete structure.

19. The method of claim 11, wherein the tang is adjustable to change an angle of the shaping element relative to a concrete structure.

20. The method of claim 11, wherein the handle is detachably attached to the tang and wherein other handles with varying offsets can be detachably attached.
